(19) United States
(12) Patent Application Publication
(10) Pub. No.: US 2026/0195830 A1
(43) Pub. Date: Jul. 9, 2026

(54) Analysis and Management Algorithm for Potential Steep Slope Areas

(71) Applicant: Republic of KOREA (National Disaster Management Research Institute), Ulsan (KR)

(72) Inventors: MI RAN LEE, Ulsan (KR); SU AH LEE, Ulsan (KR); TONG HOON LEE, Gwangmyeong-si, Gyeonggi-do (KR); JIN HUN KIM, Seoul (KR)

(21) Appl. No.: 19/303,367

(22) Filed: Aug. 19, 2025

(30) Foreign Application Priority Data
Jan. 8, 2025 (KR) 10-2025-0002638

(51) Int. Cl. G06Q 50/08; G01V 20/00; G06Q 10/04

(52) U.S. Cl. CPC G06Q 50/08; G01V 20/00; G06Q 10/04

(57) ABSTRACT

Provided is a spatial data analysis algorithm that utilizes a Digital Elevation Model (DEM) to evaluate the collapse risk of steep slopes and to effectively identify and manage hazardous areas. By utilizing high-resolution DEM data and spatial analysis techniques, the invention provides an algorithm that can identify collapse-prone areas of steep slopes and systematically manage them. Candidate areas are defined using the DBSCAN algorithm, impact ranges are calculated, and major risk factors are analyzed. Through this process, the invention enables visualization of collapse-prone areas and proposes management priorities, thereby facilitating efficient disaster prevention and urban safety management.

### TECHNICAL FIELD

This invention relates to a spatial data analysis algorithm that utilizes a Digital Elevation Model (DEM) to assess the collapse risk of steep slope areas and effectively identify and manage hazardous zones. In particular, the invention systematically evaluates the risks associated with steep slopes for the purpose of disaster prevention and urban safety management, and proposes an appropriate management framework based on the evaluation results.

In other words, the present invention relates to an analysis and management algorithm for potential steep slope areas, which utilizes terrain data and spatial analysis techniques to detect collapse risks in advance, effectively identify and manage hazardous zones, and ultimately aims to prevent disasters and enhance urban safety by significantly reducing damage caused by slope collapses and enabling the establishment of an efficient management system.

### BACKGROUND TECHNOLOGY

Approximately 63% of South Korea's territory consists of mountainous terrain, and due to urbanization and population growth, residential and commercial areas have been developed in regions that include steep slopes and artificial embankments.

These steep slope areas are highly susceptible to collapse due to steep inclines and unstable soil conditions. In particular, the likelihood of safety accidents and property damage increases with the growing risk of localized heavy rainfall, freeze-thaw cycles during the thawing season, and the potential failure of aging retaining walls and stone masonry structures.

Localized torrential rains, which are occurring more frequently due to climate change, threaten the structural stability of slopes and lead to an increase in collapse and soil runoff incidents. Additionally, freeze-thaw phenomena during the thawing season further weaken the structural integrity of slopes, potentially triggering large-scale collapses even with minor external shocks. Under these circumstances, there is a pressing need for a system that can systematically assess and appropriately manage the collapse risk of steep slopes.

In order to address these issues, the government enacted the “Act on the Prevention of Disasters at Steep Slopes” and mandated local governments and relevant agencies to designate and manage steep slope areas. However, the current designation process often relies on civil complaints or empirical judgment, highlighting the growing need for consistent and quantitative analysis criteria.

According to a 2020 study by the Ministry of the Interior and Safety, many areas designated as collapse risk zones were found to have been selected without objective criteria. To address this issue, a systematic approach utilizing terrain analysis and spatial data is required.

Conventional DEM data, such as publicly available datasets with a 30-meter resolution, provide insufficient detail for steep slope analysis, making precise evaluation difficult. To overcome this limitation, high-precision DEM data with a 1-meter resolution provided by the National Geographic Information Institute (NGII) is required for slope analysis, elevation difference assessment, and the identification of hazardous areas using clustering algorithms. While the combination of such data and analytical techniques offers essential tools for the systematic assessment and management of collapse risks in steep slope areas, traditional methods have relied solely on elevation and slope values, lacking spatial clustering techniques such as DBSCAN and more comprehensive multidimensional analysis.

Accordingly, the present invention aims to address the aforementioned issues by utilizing DBSCAN to form clusters based on slope and elevation differences, while identifying candidate areas that meet specific conditions related to length and potential impact range. At the same time, it proposes a method for identifying vulnerable elements within high-risk zones—such as multi-use facilities, facilities for the elderly and children, and aging buildings—and quantitatively evaluating the risk levels associated with these structures.

### DETAILED DESCRIPTION OF THE INVENTION

### Technical Challenges

The present invention is intended to provide an analysis and management algorithm for potential steep slope areas based on scientific and quantitative analysis, in order to minimize property damage and loss of life caused by slope collapses. More specifically, the invention aims to identify collapse-prone areas through systematic and quantitative analysis of steep slopes and to offer an efficient algorithm for their effective management.

Specifically, another objective of the present invention is to analyze detailed indicators of steep slopes using high-resolution DEM data, identify potential risk zones through the DBSCAN algorithm, calculate potential impact areas, analyze major risk factors, and determine management priorities by considering the distribution of key facilities and population within the hazardous areas.

### the Means to Solve the Problem

To achieve the above-described objectives, the analysis and management algorithm for potential steep slope areas according to the present invention comprises the following;

In a spatial data analysis algorithm for evaluating the collapse risk of steep slopes, when a Digital Elevation Model (DEM) generated from ground observation data and a land cover map generated from auxiliary spatial data are provided to a server, the server performs an analysis utilizing the DEM.

It is characterized in that pixels having a slope greater than a predetermined threshold are extracted, candidate hazardous areas are clustered by applying a DBSCAN algorithm, and only clusters satisfying both elevation difference and length conditions are derived.

In addition, the present invention comprises a step of calculating the slope of steep slope areas using high-resolution DEM data and extracting pixels having a slope greater than a predetermined threshold; and
a step of performing clustering using a DBSCAN algorithm to derive candidate areas having an elevation difference greater than a predetermined minimum threshold and a length greater than a predetermined threshold; and
a step of setting an impact range for the derived candidate areas, wherein the buffer range is limited from 1 H (one times the height of the steep slope) to a predetermined maximum value; and
a step of applying exclusion conditions based on the Road Act and the Act on the Safety Control of Public Structures through spatial overlay analysis and filtering out unnecessary areas; and
a step of aggregating the estimated affected population by applying population data on a grid-cell basis, and identifying major risk factors such as multi-use facilities and facilities for the elderly and children; and
a step of visualizing the derived hazardous areas and providing management priorities by ranking them in order of importance.

Meanwhile, the slope may be used to identify steep slope areas with a gradient of 34 degrees or more, and candidate areas having an elevation difference of 5 meters or more and a length of 20 meters or more may be defined by clustering the identified areas using the DBSCAN algorithm.

The impact range for each cluster may be determined based on the elevation difference and the size of the cluster, and the maximum impact range may be limited to 50 meters.

Risk assessment may be performed by analyzing key facility information within the hazardous areas, including multi-use facilities, aging buildings, and facilities for the elderly and children.

The present invention is also characterized in that the analysis results are provided as GIS-based visualization data so that the management authorities can intuitively understand the information.

For the defined candidate areas, a buffer is generated from a minimum of 1 H to a maximum of 50 meters based on the height of each candidate area to define the impact range, and exclusion conditions in accordance with the Road Act and the Act on the Safety Control of Public Structures may be applied to exclude certain areas from the analysis.

For the defined impact range, population data on a 100-meter grid basis may be applied to aggregate the estimated affected population, major risk factors such as multi-use facilities, facilities for the elderly and children, and aging buildings may be identified through spatial overlay analysis, and risk levels may be ranked accordingly.

When generating candidate areas for steep slopes, the resolution of the DEM data may be set to 1 meter, and digital topographic map data may be utilized to distinguish between natural slopes and artificial embankments.

When generating the impact range, areas overlapping with national parks, state-owned forests managed by the Korea Forest Service, and existing designated steep slope areas may be filtered out and excluded from the analysis.

When analyzing risk factors, data on multi-use facilities may be processed in accordance with the Indoor Air Quality Control Act standards provided by the Public Data Portal, and a comprehensive risk assessment may be performed by including data on facilities for the elderly and children.

### THE EFFECTIVENESS OF THE INVENTION

The present invention relates to a spatial data analysis algorithm that utilizes a Digital Elevation Model (DEM) to evaluate the collapse risk of steep slopes and to effectively identify and manage hazardous areas.

It enables the objective evaluation of steep slope risks through quantitative, data-driven analysis rather than conventional empirical methods, and allows the identification of even small-scale steep slopes by utilizing high-resolution DEM data, thereby providing high accuracy.

Not only does it enable comprehensive risk assessment through multi-factor analysis including slope, elevation difference, and population density, but it also enhances management efficiency through visualization and prioritization of collapse-prone areas, thereby providing a practical disaster prevention tool that can be directly utilized by local governments.

### SIMPLE EXPLANATION OF DRAWINGS

FIG. 1 is a block diagram of a basic system for executing the analysis and management algorithm for potential steep slope areas according to the present invention;

FIG. 2 is a basic logic diagram of the analysis and management algorithm for potential steep slope areas according to the present invention;

FIG. 3 is a flowchart of the analysis and management algorithm for potential steep slope areas according to the present invention;

FIG. 4 is a diagram illustrating the process of setting the impact range and generating polygons in the present invention;

FIG. 5 is a detailed flowchart of the analysis and management algorithm for potential steep slope areas according to the present invention.

FIG. 6 is a first example of a monitor screen displaying the potential steep slope areas derived according to the present invention;

FIG. 7 is a second example of a monitor screen displaying the potential steep slope areas derived according to the present invention;

FIG. 8 is a third example of a monitor screen displaying the potential steep slope areas derived according to the present invention;

FIG. 9 is a fourth example of a monitor screen displaying the potential steep slope areas derived according to the present invention;

FIG. 10 is a fifth example of a monitor screen displaying the potential steep slope areas derived according to the present invention.

### SPECIFIC DETAILS FOR IMPLEMENTING THE INVENTION

Hereinafter, a preferred embodiment of the present invention will be described in more detail with reference to the accompanying drawings. However, it should be understood that the scope of the present invention is not limited thereto.

In this specification, the embodiment is provided to fully disclose the present invention and to sufficiently inform those skilled in the art of the scope of the invention. The scope of the present invention is defined only by the claims. Accordingly, in some embodiments, well-known components, operations, and techniques are not described in detail in order to avoid obscuring the essence of the present invention.

The terms used in this specification are intended to describe exemplary embodiments and are not intended to limit the present invention. As used herein, the singular forms also include the plural forms unless the context clearly indicates otherwise. Furthermore, components or operations referred to as “including” or “comprising” do not exclude the presence or addition of one or more other components or operations.

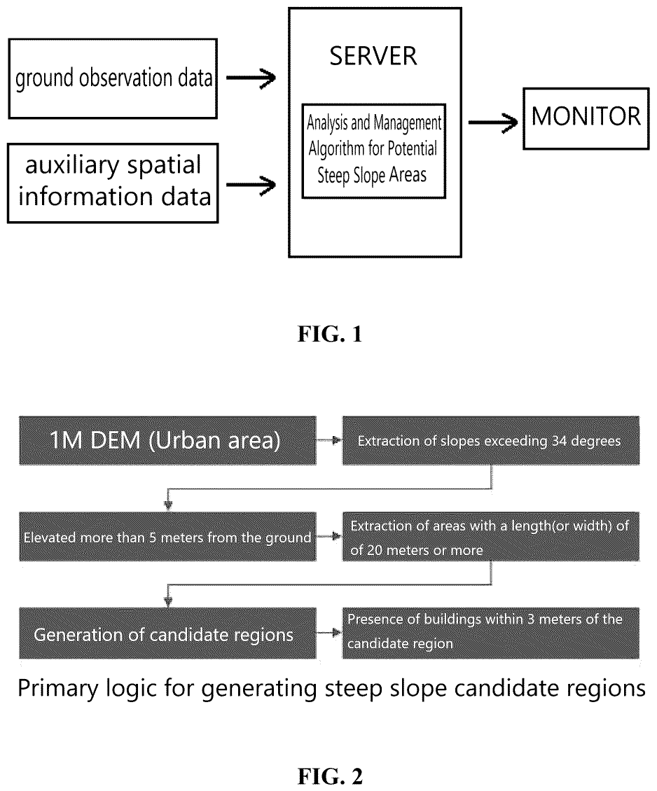

FIG. 1 is a block diagram of a basic system for executing the analysis and management algorithm for potential steep slope areas according to the present invention.

When a Digital Elevation Model (DEM) generated from ground observation data and a land cover map generated from auxiliary spatial data are provided to a server, the analysis and management algorithm for potential steep slope areas according to the present invention is executed within the server. The resulting output is displayed on a monitor in a state mapped to the land cover map, thereby enabling the user to evaluate the collapse risk of steep slopes and to effectively identify and manage hazardous areas.

FIG. 2 is a basic logic diagram of the analysis and management algorithm for potential steep slope areas according to the present invention. In the present invention, a foundational logic was established to define steep slope areas based on spatial data and analytical techniques, and candidate areas were generated and reviewed accordingly.

That is, steep slope areas can be derived by converting DEM data into slope data; however, in order to satisfy conditions such as length and height, it is not feasible to use publicly available data with a spatial resolution of 30 meters, and even with restricted-access 5-meter resolution data, it is difficult to detect small-scale steep slopes.

Therefore, slope data were generated using 1-meter resolution DEM data, which are restricted-access and primarily available for urban areas, and only pixels with a slope of 34 degrees or more were extracted therefrom.

Next, the centroids of the extracted pixels were obtained, and since at least 40 centroids must be grouped together to satisfy the minimum length and height conditions, only the clustered points were extracted using a spatial clustering technique called DBSCAN.

Subsequently, a condition of having at least 5 meters in elevation from the ground was applied; however, since the “ground” does not have an absolute reference, it was determined as the lowest elevation point within each candidate area. To assess the lowest and highest elevations within each candidate area, only those clusters in which the elevation difference among the points exceeded 5 meters were extracted as candidate areas.

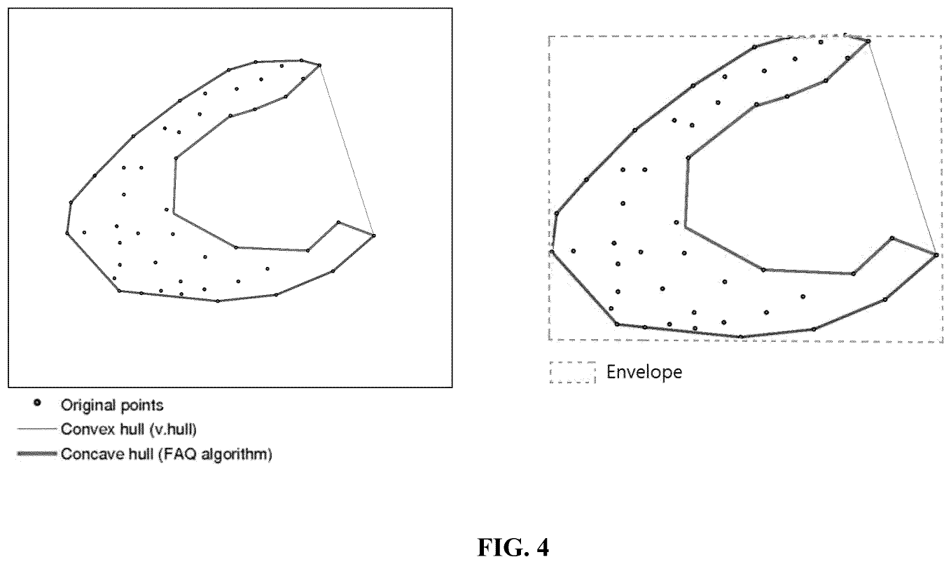

Next, in order to satisfy the condition of having a length of 20 meters or more, a polygon was generated by connecting the outermost points of each cluster. At this time, it is preferable to generate the polygon using a Concave Hull rather than a Convex Hull, so as to avoid including unnecessary areas that are not part of the actual steep slope. (See FIG. 4)

Since the polygon is not in a uniform shape such as a rectangle but rather in a highly irregular form, it is difficult to define an absolute “length” based on a fixed standard. Therefore, the envelope of the polygon is obtained, and polygons in which the longer side of the resulting rectangular envelope is 20 meters or more are extracted. This approach ensures that the length is conservatively estimated compared to visual inspection, thereby sufficiently satisfying the required criteria.

However, as a result of field inspections conducted on the candidate areas generated according to the first-stage logic described above, it was confirmed that while the candidate areas could be effectively reviewed, there was a limitation in that the areas included targets that should be excluded under the Road Act and the Act on the Safety Control of Public Structures, making it unsuitable for direct application in practice unless such unnecessary targets are filtered out.

In addition, under the Act on the Prevention of Disasters at Steep Slopes, areas designated and publicly notified due to concerns of collapse or falling rocks among steep slopes are referred to as “collapse risk areas,” and it is stipulated that not only the candidate steep slope areas but also the surrounding land must be included.

As a result of reviewing the “Steep Slope Management Manual” published by the Ministry of the Interior and Safety, previous related studies by the National Disaster Management Research Institute, and overseas research cases, it was found that the impact range is generally defined as twice the height of the steep slope for the lower side and once the height for the upper side, with an upper limit of 50 meters.

While such distinctions between the upper and lower sides can be made theoretically or through human judgment in the field, it is difficult to distinguish them in irregularly shaped candidate areas. Therefore, the standard is set such that the impact range is generated by applying a buffer equal to at least 1 H (i.e., the height of the steep slope) without exceeding a maximum of 50 meters. For each candidate area, a buffer zone corresponding to its height is created, provided that it does not exceed 50 meters, and all subsequent exclusion processing and aggregation of population/building data are carried out based on this defined impact range.

Retaining walls and cut-and-fill slopes related to artificial embankments are provided as linear layers in the publicly available digital topographic maps offered by the National Geographic Information Institute, and are constructed using this data.

Among the Type 1 and Type 2 facilities, buildings can be identified under similar conditions, although not with 100% accuracy. Therefore, an exclusion condition is applied for buildings that meet the criteria of Type 2 facilities including the Type 1 standard, specifically buildings with 16 or more floors or a total floor area of 30,000 square meters or more.

Based on residential buildings, the number of floors is calculated by dividing the building height by 3 meters, and the total floor area is obtained by multiplying the base area by the number of floors. If a building located within the impact range has 16 or more floors, or a total floor area of 30,000 square meters or more, the corresponding area is excluded from the candidate steep slope area.

In addition, based on the final review by the Disaster Information Research Division, areas with an elevation difference of 50 meters or more are classified as natural slopes, and in the case of artificial slopes, only candidate areas that spatially intersect with cut-and-fill slopes or retaining walls are considered applicable. Furthermore, the logic was refined to exclude impact range areas adjacent to expressways, urban expressways, and national highways as defined in the Ministry of Land, Infrastructure and Transport's standard road link data, as well as areas overlapping with national parks, state-owned forests and landslide-prone areas designated by the Korea Forest Service, and areas adjacent to previously designated steep slopes.

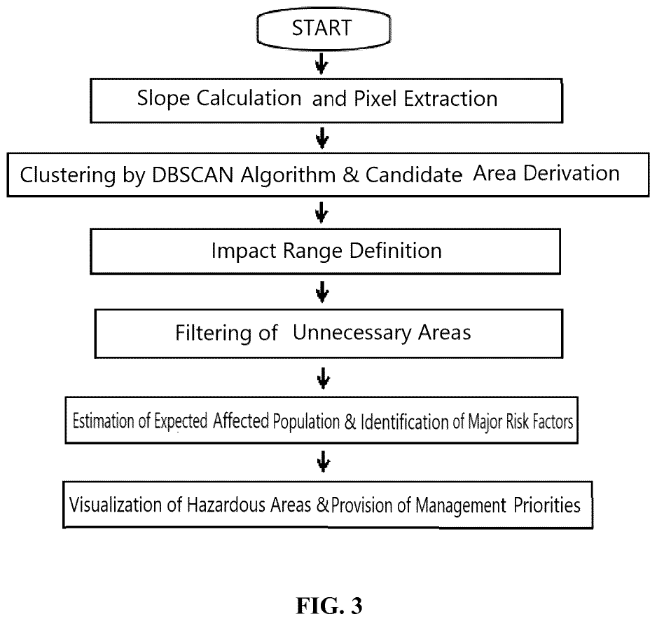

FIG. 3 is a flowchart of the analysis and management algorithm for potential steep slope areas according to the present invention, and the algorithm is performed through the following processes:
a process of generating a slope map based on 1-meter resolution DEM data and extracting pixels with a slope of 34 degrees or more, which serves as the data collection and preprocessing stage for the subsequent DBSCAN clustering; and
a process of applying a clustering algorithm using the DBSCAN method to generate clusters consisting of at least 40 centroids, wherein the clusters satisfy the conditions of having an elevation difference of 5 meters or more and a length of 20 meters or more; and
a process of calculating the impact range by setting a lower buffer of 2 H and an upper buffer of 1 H (up to a maximum of 50 meters) based on the elevation difference of each cluster, wherein a more accurate polygon is generated using a Concave Hull instead of a Convex Hull; and
a process of analyzing facilities located within hazardous areas by utilizing data on multi-use facilities, facilities for the elderly and children, and aging buildings provided by the National Geographic Information Institute and public data sources, and calculating the estimated affected population using 100-meter grid population data from the National Land Statistical Map; and
a process of integrating the final hazardous areas, impact ranges, and key facility information to generate GIS-based visualization materials and to automatically generate a report.

That is, the analysis and management algorithm for potential steep slope areas according to the present invention is a spatial data analysis algorithm utilizing a Digital Elevation Model (DEM) to evaluate the collapse risk of steep slopes.

It is characterized by extracting pixels having a slope greater than a predetermined threshold, applying the DBSCAN algorithm to cluster candidate hazardous areas, and deriving only those clusters that satisfy the elevation difference and length conditions; and a step of calculating the slope of steep slopes using high-resolution DEM data and extracting pixels having a slope greater than a predetermined threshold;
a step of performing clustering using the DBSCAN algorithm to derive candidate areas that satisfy a minimum elevation difference threshold and a minimum length threshold;
a step of setting an impact range for the derived candidate areas, wherein the buffer range is limited from one times the height (1 H) of the steep slope to a predetermined upper limit;
a step of applying exclusion conditions in accordance with the Road Act and the Act on the Safety Control of Public Structures through spatial overlay analysis and filtering out unnecessary areas;
a step of aggregating the estimated affected population by applying population data on a grid-cell basis and identifying key risk factors such as multi-use facilities and facilities for the elderly and children; and
a step of visualizing the derived hazardous areas and providing management priorities by ranking them according to importance.

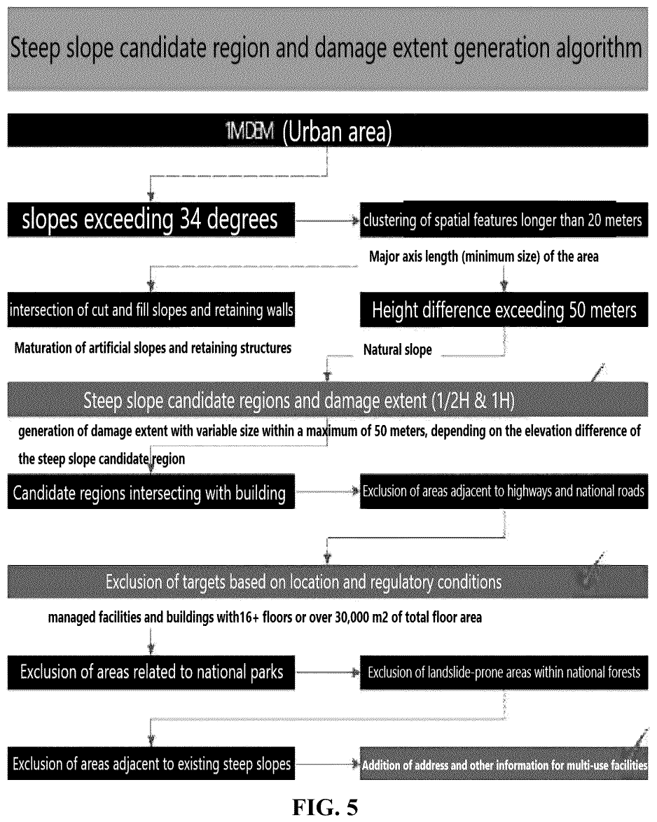

Meanwhile, FIG. 5 is a detailed flowchart of the analysis and management algorithm for potential steep slope areas according to the present invention.

The analysis and management algorithm for potential steep slope areas according to the present invention has the advantage of enabling review based on the level of importance (risk level), as it allows for the aggregation of population data and identification of multi-use facilities within the derived impact range, and for the results to be sorted and viewed accordingly.

Immediately after the algorithm was refined, the National Disaster Management Research Institute provided data containing coordinate or address information on landslide-prone areas, steep slopes, and facilities subject to management under the Act on the Safety Control of Public Structures. By applying this data, new candidate steep slope areas and impact range areas for the pilot site, Busan Metropolitan City, were able to be generated.

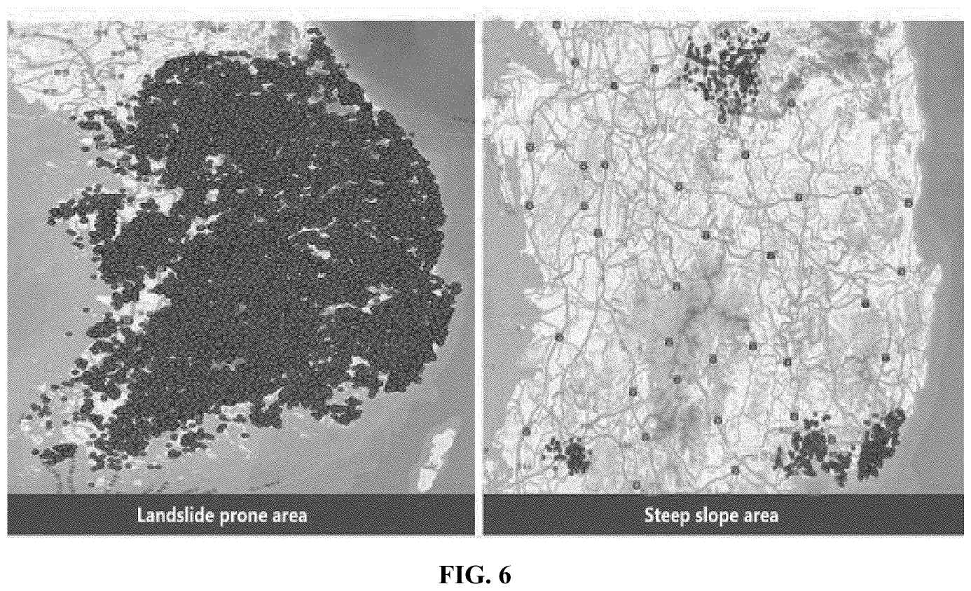

As a result of reviewing the generated candidate areas and impact range areas, unnecessary regions such as existing steep slopes, managed facilities, and landslide-prone areas were minimized, thereby enabling local government officials to conduct additional reviews while managing existing designated steep slope (collapse risk) areas. (See FIG. 6)

The analysis and management algorithm for potential steep slope areas according to the present invention is a complete and practical algorithm, as it enables each local government to easily generate candidate steep slope areas by utilizing publicly available data, provided that the 1-meter DEM from the National Geographic Information Institute is used together with internally managed steep slope and facility data that have been geocoded.

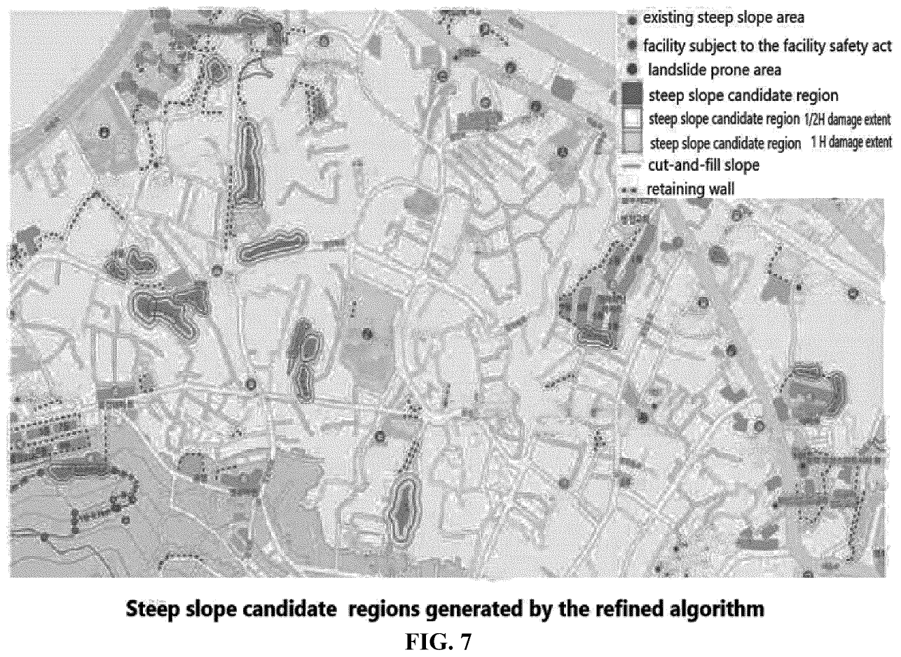

FIG. 7 is a second example of a monitor screen displaying the potential steep slope areas derived according to the present invention. Along with this, point data can be generated by utilizing the coordinates included in an Excel file containing the 13 types of human casualty risk area data from the Storm and Flood Management System. Outliers located outside the territorial waters or in North Korea are excluded to ensure valid point location data.

A comparison was made between the steep slope data of the flood, drought, and steep slope management system and the steep slope areas classified as human casualty risk zones; however, due to significant differences in the number of data entries and attribute information, it was determined that integrating and utilizing the datasets would be difficult.

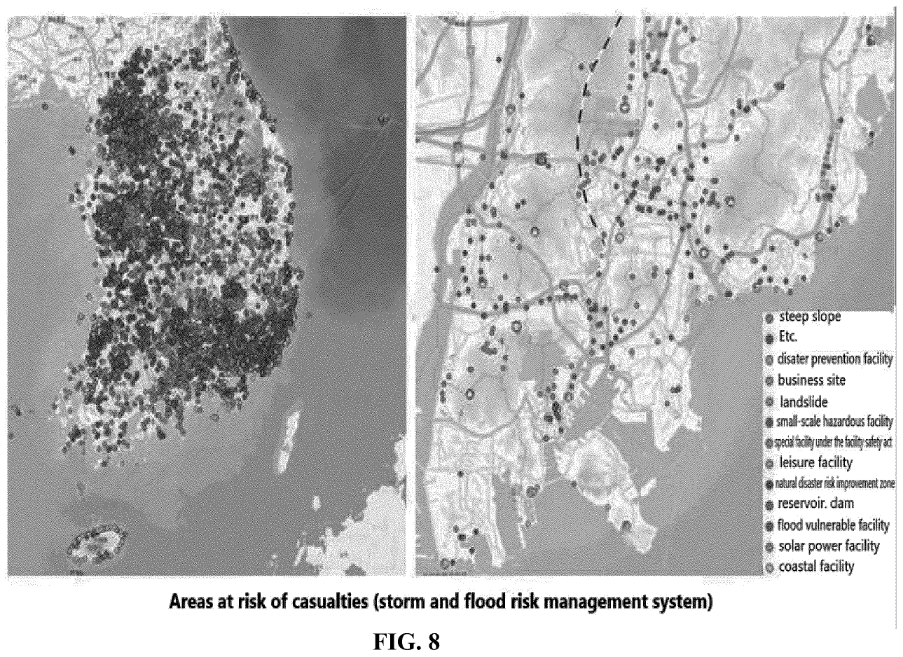

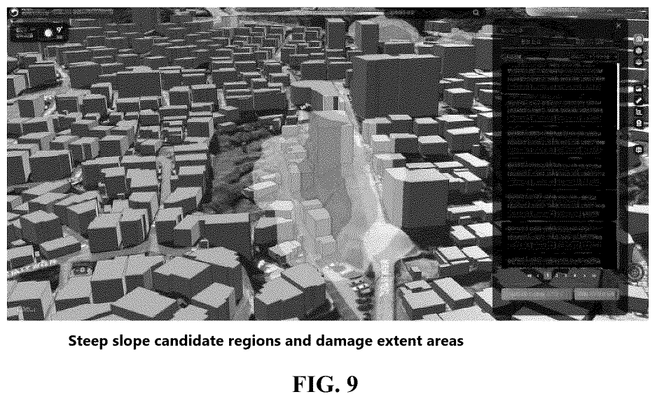

In addition, FIG. 8 is a third example of a monitor screen displaying the potential steep slope areas derived according to the present invention. As shown in the figure below, categorical visualization was performed for each of the 13 types of human casualty risk areas, and these were additionally applied as thematic maps within the system for reference purposes.

In addition, after generating the candidate areas and impact range areas using the steep slope candidate area derivation algorithm, a process was carried out to determine which of the candidate or impact range areas poses a greater risk by aggregating population data and identifying major facilities such as multi-use facilities within each impact range area.

Once the steep slope impact range areas were generated, they were spatially joined with the National Land Statistical Map to aggregate the total population, infant population, and elderly population within each impact range area. Although the actual damage may vary depending on the form or scale of collapse, it is reasonable to prioritize review of areas with larger populations, as this allows for the estimation of the maximum expected affected population based on a consistent criterion. Furthermore, since a collapse occurring in the candidate area may also affect the upper or lower portions of the impact range, population aggregation was conducted based on the impact range areas.

Since the candidate areas are not assumed to collapse entirely, but rather represent areas to which basic risk conditions are applied, it is more likely that only partial collapse will occur, primarily around points where leakage or cracks have developed. Therefore, if the concept of normalization is applied—by dividing the aggregated population by the area of the impact range polygon to convert it into population density—the order of items may change when sorted in descending order. Such aspects can be sufficiently reviewed and refined during the practical application stage or the pilot site testing phase.

FIG. 9 is a fourth example of a monitor screen displaying the potential steep slope areas derived according to the present invention.

Information that should be considered in terms of importance along with population includes multi-use facilities, facilities for the elderly and children such as nursing homes, educational and administrative facilities, and aging buildings.

The term “multi-use facility” is defined in the Framework Act on the Management of Disasters and Safety as “a facility used by an unspecified number of people, as prescribed by Presidential Decree.” The Indoor Air Quality Control Act further specifies the applicable facilities as public facilities such as libraries, public transportation facilities such as terminals, commercial facilities such as department stores, and cultural facilities such as theaters. Accordingly, multi-use facility data provided by local governments through platforms such as the Public Data Portal include address information for facilities subject to the Indoor Air Quality Control Act.

In addition, “elderly care facilities” are defined in the Welfare of the Aged Act and related regulations, and include nursing homes, senior welfare housing, and group homes for the elderly. Since these facilities house elderly individuals with limited mobility, they must be included in the scope of assessment. When the scope is expanded to include daycare centers and kindergartens along with elderly care facilities, they can be collectively referred to as facilities for the elderly and children. However, because the availability, format, and inclusion of detailed addresses or coordinates in such data vary by local government, building a consistent dataset is challenging.

The data provided as “standard data” on the Public Data Portal are standardized datasets that address these issues by integrating information on a nationwide scale and including coordinate data, thereby offering improved compatibility, reusability, and data quality. However, it has been identified that no nationwide standard dataset currently exists for elderly care facilities.

For educational and administrative facilities, the location information of civil service institutions such as elementary, middle, and high schools, and community service centers is utilized from the Road Name Address Electronic Map. If multi-use facilities, facilities for the elderly and children, or educational and administrative facilities are included in a steep slope collapse area, the potential number of affected individuals may exceed the resident population. Therefore, such facilities must be critically considered in the assessment.

In addition, aging buildings must also be critically considered, as they are more likely to sustain severe damage under the same impact due to their deteriorated condition. The presence of such facilities and aging buildings should be identified by performing spatial overlay analysis between the impact range areas and the respective facility and building layers.

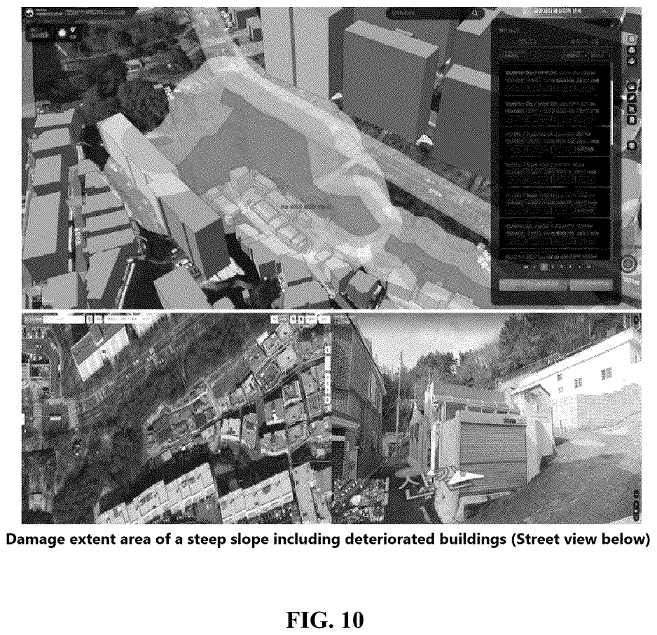

FIG. 10 is a fifth example of a monitor screen displaying the potential steep slope areas derived according to the present invention.

A case review of an area where aging buildings were identified shows that the cut slope along a road corresponds to the candidate steep slope area, and the impact range area at the lower section includes small detached houses, among which buildings older than 30 years appear to be present.

As such, since it is difficult for local government officials to investigate all areas within their jurisdiction and to visually determine whether the conditions defined under the Steep Slope Management Act are quantitatively satisfied, the present invention is expected to assist in identifying areas that have not been previously detected.

As described above, in the analysis and management algorithm for potential steep slope areas according to the present invention,

It enables the objective assessment of steep slope risks through quantitative, data-driven analysis rather than conventional empirical methods, and allows for the identification of even small-scale steep slopes by utilizing high-resolution DEM data, thereby providing high accuracy.

Not only does it enable comprehensive risk assessment through multi-factor analysis including slope, elevation difference, and population density, but it also improves management efficiency through visualization and prioritization of collapse-prone areas, thereby serving as a practical disaster prevention tool that can be directly utilized by local governments.

Although the technical spirit of the present invention has been specifically described with reference to preferred embodiments, it should be understood that such embodiments are provided for illustrative purposes only and are not intended to limit the scope of the invention. Various modifications and alterations within the scope of the technical spirit of the present invention will be apparent to those skilled in the art, and it is therefore self-evident that such modifications and alterations fall within the scope of the appended claims.

What is claimed is:

1. An analysis and management algorithm for potential steep slope areas, wherein, when a digital elevation model (DEM) generated from ground observation data and a land cover map generated from auxiliary spatial data are provided to a server, the collapse risk of steep slopes is evaluated within the server using the DEM, wherein pixels having a slope greater than a predetermined threshold are extracted, a DBSCAN algorithm is applied to cluster candidate hazardous areas, and only clusters satisfying both elevation difference and length conditions are derived, the algorithm comprising:
(a) calculating the slope of steep slopes using high-resolution DEM data and extracting pixels having a slope greater than a predetermined threshold;
(b) performing clustering using a DBSCAN algorithm to derive candidate areas having both an elevation difference greater than a predetermined minimum threshold and a length greater than a predetermined minimum threshold;
(c) setting an impact range for the derived candidate areas, wherein a buffer range is limited from one times the height (1 H) of the steep slope to a predetermined maximum limit;
(d) performing spatial overlay analysis to apply exclusion conditions in accordance with the Road Act and the Act on the Safety Control of Public Structures, and filtering out unnecessary areas;
(e) aggregating the estimated affected population by applying grid-based population data and identifying major risk factors including multi-use facilities and facilities for the elderly and children; and
(f) visualizing the derived hazardous areas and providing management priorities by ranking them according to importance, wherein the impact range for each cluster is determined based on the elevation difference and the size of the cluster, and the maximum impact range is limited to 50 meters.

2. The algorithm according to claim 1,
wherein the slope is used to identify steep slope areas with an inclination of 34 degrees or more, and candidate areas are defined by clustering such areas using a DBSCAN algorithm,
wherein the candidate areas satisfy the conditions of having an elevation difference of 5 meters or more and a length of 20 meters or more.

3. The algorithm according to claim 1,
wherein key facility information including multi-use facilities, aging buildings, and facilities for the elderly and children is analyzed within the hazardous areas to perform risk assessment.

4. The algorithm according to claim 1, wherein the analysis results are provided as GIS-based visualization data so that the management authorities can intuitively understand the information.

5. The algorithm according to claim 1,
wherein for each defined candidate area, a buffer is generated based on the height of the candidate area, ranging from a minimum of 1 H to a maximum of 50 meters to define an impact range area,
and exclusion conditions in accordance with the Road Act and the Act on the Safety Control of Public Structures are applied to exclude such areas from the analysis target.

6. The algorithm according to claim 1,
wherein population data on a 100-meter grid basis is applied to the defined impact range areas to aggregate the estimated affected population,
major risk factors such as multi-use facilities, facilities for the elderly and children, and aging buildings are identified through spatial overlay analysis,
and risk levels are ranked accordingly.

7. The algorithm according to claim 1,
wherein, when generating the candidate steep slope areas, the resolution of the DEM data is set to 1 meter, and digital topographic map data is utilized to distinguish between natural slopes and artificial embankments.

8. The algorithm according to claim 1,
wherein, when generating the impact range areas, regions overlapping with national parks, state-owned forests managed by the Korea Forest Service, and existing designated steep slope areas are filtered out and excluded from the analysis.

9. The algorithm according to claim 1,
wherein, when analyzing risk factors, multi-use facility data is processed in accordance with the standards of the Indoor Air Quality Control Act provided by the Public Data Portal, and a comprehensive risk assessment is performed including data on facilities for the elderly and children.
